(19) United States
(12) Patent Application Publication
(10) Pub. No.: US 2011/0117888 A1
(43) Pub. Date: May 19, 2011

(54) Signalling Optimisation In A Presence Service

(75) Inventors: Mikael Lars Klein, Huddinge (SE); Christer Carl Boberg, Tungelsta (SE); Sofie Lassborn, Sollentuna (SE); Anders Lindgren, Alvsjo (SE)

(73) Assignee: Telefonaktiebolaget LM Ericsson (Publ), Stockholm (SE)

(21) Appl. No.: 12/996,994

(22) PCT Filed: Jul. 1, 2008
(86) PCT No.: PCT/EP2008/058459

§ 371 Date: Feb. 8, 2011

(51) Int. Cl. H04M 1/663

(52) U.S. Cl. 455/412.2

(57) ABSTRACT

A method of handling notifications associated with a presence service provided over a communications network and to which service a plurality of users are subscribed. The method comprises subscribing a first user to presence information of one or more peer users. In the event that a notification is sent from said network towards a first user, the notification containing presence information relating to the or at least one of said peer users, any failure to deliver said notification is detected and the notification sent one or more times.

### TECHNICAL FIELD

The present invention relates to signalling optimisation in a presence service and in particular, though not necessarily, to such signalling optimisation in a presence service provided by an IP Multimedia Subsystem.

### BACKGROUND

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The UMTS (Universal Mobile Telecommunications System) is a third generation wireless system designed to provide higher data rates and enhanced services to subscribers. The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 8). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

Specific details of the operation of the UMTS communications network and of the various components within such a network can be found from the Technical Specifications for UMTS that are available from http://www.3gpp.org. Further details of the use of SIP within UMTS can be found from the 3GPP Technical Specification TS 24.228.

FIG. 1 of the accompanying drawings illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

Within the IMS service network, Application Servers (ASs) are provided for implementing IMS service functionality. Application Servers provide services to end-users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment. Different IFCs may be applied to different call cases. The IFCs are received by the S-CSCF from an HSS during the IMS registration procedure as part of a user's User Profile. Certain Application Servers will perform actions dependent upon subscriber identities (either the called or calling subscriber, whichever is “owned” by the network controlling the Application Server). For example, in the case of call forwarding, the appropriate (terminating) application server will determine the new terminating party to which a call to a given subscriber will be forwarded. In the case that an IFC indicates that a SIP message received at the S-CSCF should be forwarded to a particular SIP AS, that AS is added into the message path. Once the SIP message is returned by the AS to the S-CSCF, it is forwarded on towards its final destination, or forwarded to another AS if this is indicated in the IFCs.

The standard for SIP based communication is defined by the RFC 3261 and for event notification RFC 3265. The latter RFC introduces the SUBSCRIBE and NOTIFY methods, which enables a client to subscribe for events. A NOTIFY is sent by the server when a new event has occurred. These two methods together with the PUBLISH method (RFC 3904) are the standard methods used for the Presence service. This service allows users to publish their presence information using the PUBLISH method. Other users (“watchers”) subscribe to presence information of a given user (“presentity”) using the SUBSCRIBE method, with published information being distributed to watchers using the NOTIFY method.

RFC 4662 provides for a Resource List Server (RLS) which is able to perform multiple “backend” subscriptions on behalf of a user. Users publish their presence information on their local presence servers (PSs), and a watching user must subscribe to that server in order to access the information. When a user subscribes to the RLS, the RLS performs the multiple backend subscriptions to the relevant PSs. Furthermore, the RLS aggregates NOTIFY messages received from different PSs over some time period (e.g. a few seconds) into a single NOTIFY and forwards this on to the watching user. These mechanisms result in a significant reduction in signalling traffic.

According to the presence service, a user (the “first user”) subscribes to the presence information of peer users. As long as the first user is subscribed, he or she will receive NOTIFY messages containing the status of the peer users. The first user's own presence information is communicated to the presence system, and is distributed to peer users that have subscribed to the presence information of the first user. It will be appreciated that the subscriptions can be separately terminated, i.e. the first user may terminate his subscription to receive presence information from peer users, whilst those peer users maintain their subscriptions to receive presence information from the first user.

The SIP standardization work does not normally consider the access network used in the communication and often the traditional wired Internet is assumed in which delays and network coverage are not a problem. A potential problem in applying the SIP Presence service to a mobile wireless environment arises as a result of the assumption that a watching subscription is supposed to be terminated/removed if a recipient of a NOTIFY cannot be reached. As stated in RFC3265, chapter 3.2.2, if the NOTIFY request fails due to an error response, and the watching subscription was installed using a soft-state mechanism, the notifier must remove the corresponding watching subscription. In the case of a mobile wireless network, a user may be unreachable when entering for example a tunnel, a building, or a subway. When the user recovers connectivity, the subscription may have been terminated and hence the subscription must be set up again. [This re-establishment of the subscription may not occur for some time (e.g. several hours) if the user is unaware that the subscription has been terminated and if a long expiration (refresh) value is used.] This is potentially a problem as every time a new subscription is created a great deal of traffic is generated.

It is noted that the user's own presence status is not affected by the termination of the watching subscription during loss of radio coverage. Rather, if a user's status in the presence system has not been updated after some predefined period, that status will “expire” and the user will be indicated as offline and that new status relayed to those peer users that have subscribed to it.

Assume that a user has 30 contacts in his or her contact list. After a NOTIFY is sent out by a network server to that user and a “408 Request Timeout” (user unreachable due to out of coverage) is returned, a Resource List Server (RLS) will terminate all backend subscriptions with the relevant PSs. Each termination of a backend subscription generates four messages (SUSCRIBE exp=0, 200 OK, NOTIFY terminated, 200 OK) in the network. In addition to this, when the user's client detects that the subscription is terminated it will create a new subscription, in which case each backend subscription generates another four messages (SUSCRIBE exp>0, 200 OK, NOTIFY active, 200 OK) plus the RLS notification. That is, for subscription termination: 30*4=120 messages are required, and for subscription activation: 1+30*4+1=122 messages are required, i.e. a total of 242 messages.

WO99/34628 describes a presence service and identifies as a problem the temporary loss of mobile connectivity for users and the resulting potentially large volume of signalling. However, this document is concerned with reducing the volume of signalling traffic towards watchers of a user that has temporarily lost radio coverage, with the proposed solution involving a presence system checking with the network (HLR) to determine a user's status, repeating that check after some predefined period has elapsed, and only notifying the watchers if both checks indicate that the user is off-line. WO99/34628 does not identify as a problem the requirement to terminate backend subscriptions when a user temporarily looses network coverage and the resulting high volume of signalling traffic.

### SUMMARY

It is an object of the present invention to reduce the volume of backend subscription related signalling in a presence system. This object is achieved by providing a retry mechanism for the sending of notification messages to a watcher, in order to prevent the early termination of the watcher's subscription when the watcher temporarily looses network access.

According to a first aspect of the present invention there is provided a method of handling notifications associated with a presence service provided over a communications network and to which service a plurality of users are subscribed. The method comprises subscribing a first user to presence information of one or more peer users. In the event that a notification is sent from said network towards a first user, the notification containing presence information relating to the or at least one of said peer users, any failure to deliver said notification is detected and the notification sent one or more times.

According to one embodiment of the invention, in the event that said resending fails a predefined number of times, no further resends are attempted. However the subscription of said first user to presence information of said one or more peer users is maintained, thus avoiding the need for unnecessary backend signalling. The notification may be buffered within the network following the final resend attempt and, upon occurrence of a further notification event, included with a further notification sent towards said first user.

In an alternative embodiment of the invention, in the event of repeated failure to deliver said notification, the subscription of said first user to presence information of said one or more peer users may be terminated.

The invention is applicable to the case where said presence service is a SIP-based service, and said notification is a SIP NOTIFY. In this case, failure to deliver a notification may be detected by receipt of one of:

408 Request Timeout;

480 Temporarily Unavailable;

486 Busy Here;

500 Server Internal Error;

503 Service Unavailable;

504 Server Time-out;

600 Busy Everywhere.

A particular application of the invention is to a presence service in the IP Multimedia Subsystem, in which case the method is carried out at an IP Multimedia Subsystem Application Server, e.g. a Resource List Server.

According to a second aspect of the present invention there is provided apparatus configured to handle notifications of presence information associated with a presence service provided over a communications network and to which service a plurality of users are subscribed. The apparatus comprises a sending unit for sending a notification towards a first user, the notification containing presence information relating to one or more peer users, and a failure detection unit for detecting a failure to deliver said notification. A resending unit is provided for causing said notifications to be resent one or more times.

Said resending unit may comprise a counter for counting the number of resend attempts, the apparatus further comprising a processing unit for terminating the resending attempts if the counter exceeds a preconfigured number, whilst maintaining the subscription of said first user to presence information of said one or more peer users. The apparatus may further comprise a buffer, the processing unit being configured to store said notification in the buffer should the number of resend attempts exceed said preconfigured number.

The apparatus may be configured to operate as an Application Server within an IP Multimedia Subsystem, e.g. a Resource List Server.

According to a third aspect of the present invention there is provided a method of handling notifications associated with a presence service provided over a communications network and to which service a plurality of users are subscribed. The method comprises sending a notification from said network towards a first user, the notification containing a request by a second user to subscribe to the presence information of said first user. Any failure to deliver said notification is detected and the notification resent one or more times.

In the event that said resending fails a predefined number of times, no further resends may be attempted, whilst maintaining the subscription of said first user to presence information of one or more peer users.

According to a fourth aspect of the present invention there is provided a method of handling notifications associated with a document change watching service provided over a communications network and to which service a first user is subscribed. The method comprises sending a notification from said network towards said first user, the notification containing details of one or more changes to a document residing in the network, and detecting a failure to deliver said notification. In case of such a failure, the notification is resent one or more times.

This aspect of the invention is applicable to the case where said document is an XML document held on an XDMS within an IMS network, e.g. a document containing user data such as contact data.

### BRIEF DESCRIPTION OF THE DRAWINGS

FIG. 1, discussed hereinbefore, illustrates schematically the integration of an IP Multimedia Subsystem into a 3G mobile communications system;

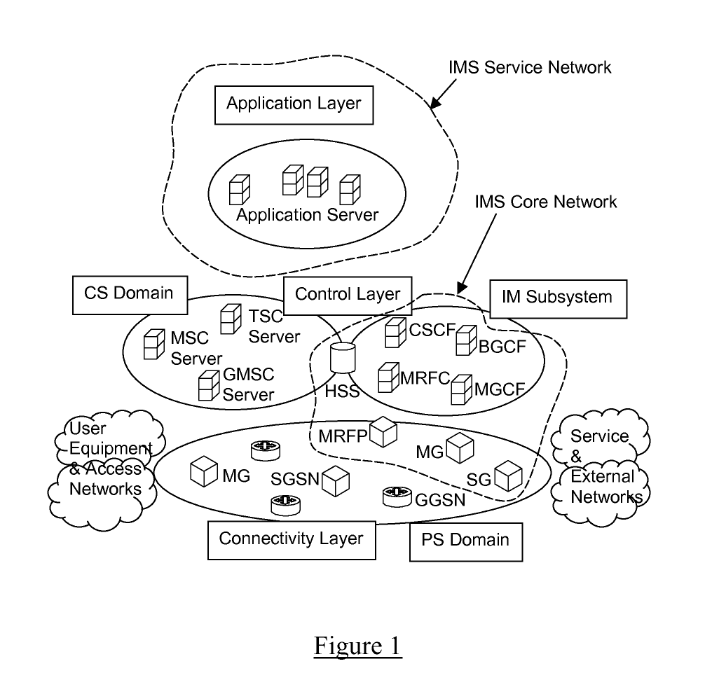

FIG. 2 illustrates a signalling flow associated with an IMS presence service;

FIG. 3 illustrates schematically a Resource List Server of an IMS network; and

FIG. 4 is a flow diagram illustrating a process for handling NOTIFY messages.

### DETAILED DESCRIPTION

As has been outlined above, according to the existing SIP RFCs, receipt of an error response (such as 408) from a user terminal as a result of sending a presence NOTIFY to that terminal will result in the termination of the user's subscription within the presence service. In order to avoid this happening during the temporary loss of radio coverage in a wireless mobile network, it is proposed here to perform a number of attempts to re-send the NOTIFY within a configurable time interval, or alternatively to attempt a configurable number of NOTIFY resends. Retries are also attempted if the terminal or a network component (e.g. CSCF) is currently overloaded causing it to send a 503 Service Unavailable back to PGM.

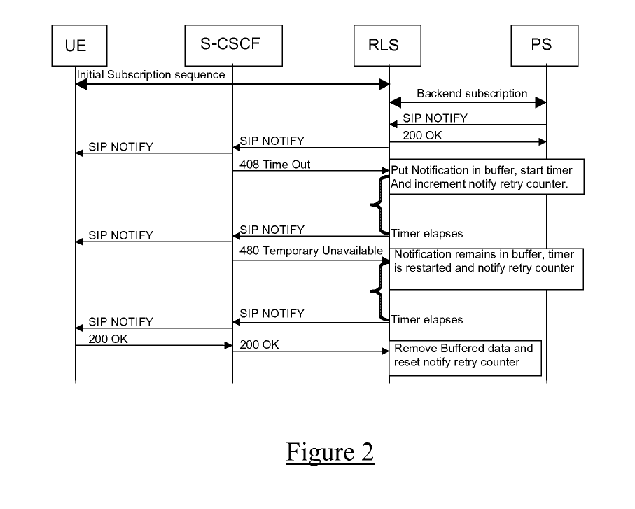

FIG. 2 illustrates an example signalling flow between the user (UE) and the IMS network, and within the IMS network, for the case where the user temporarily looses network coverage for a short period. The Figure illustrates an initial subscription sequence between the UE and the RLS. In this sequence the UE will typically identify a list or group of peer users that it wishes to watch, e.g. a “buddy” list. The RLS then performs the backend subscriptions with the relevant PSs (only one of which is illustrated in the Figure).

Assume that subsequently a first attempt to send a NOTIFY to the UE times out at the S-CSCF. The receipt of the 408 Time Out at the RLS causes the RLS to buffer the notification, initialise a timer, and increment a NOTIFY retry counter. Upon expiry of the timer, a further NOTIFY is sent to the UE. In this case a 480 Temporarily Unavailable is returned (although it could equally have been a further 408 or 503). The NOTIFY sending procedure is repeated until the notification is successful and a “200 OK” response is received from the UE or until a pre-configured number of retry attempts is exceeded in which case the retry sequence is cancelled. Other messages that may trigger the resending of the NOTIFY include a 486 Busy Here, 500 Server Internal Error, 504 Server Timeout, and 600 Busy Everywhere. This list is not intended to be exhaustive.

It will be appreciated that the procedure for retrying the NOTIFY sending distinguishes the present approach from the currently proposed mechanisms, whereby only one attempt is made to send the NOTIFY. A further distinction is that if the attempt limit is exceeded, the notification information remains in a notification buffer at the RLS and the information will be included when an event occurs that triggers a new notification, e.g. a new NOTIFY arrives from the PS. The failure of the original NOTIFY does not cause the UE's watching subscription to be terminated.

In addition to reducing network traffic, the procedure described above helps conserve battery power within mobile terminals (belonging to watchers of the temporarily offline UE) since fewer messages are sent/received.

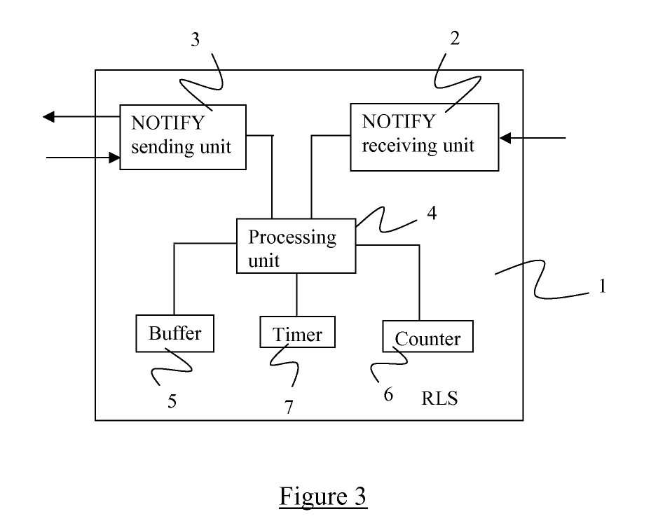

FIG. 3 illustrates schematically a modified RLS 1 suitable for implementing the procedure described above. As existing RLS functionality, the RLS includes a NOTIFY receive unit 1 for receiving NOTIFY messages from PSs. A NOTIFY sending unit 3 is configured to handle the sending of NOTIFY messages towards (watching) UEs that have subscribed to the RLS, and to monitor the delivery of these messages. A processor 4 is responsible for aggregating incoming NOTIFY messages and for handling the described retry functionality. The processor 4 is coupled to a notification buffer 5. The processor stores notification data in the buffer 5 in the event that a repeated attempt to send a NOTIFY has failed. The processor is also coupled to a counter 6 which counts the number of retries made for a NOTIFY message, and to a timer 7 which maintains the intervals between resends.

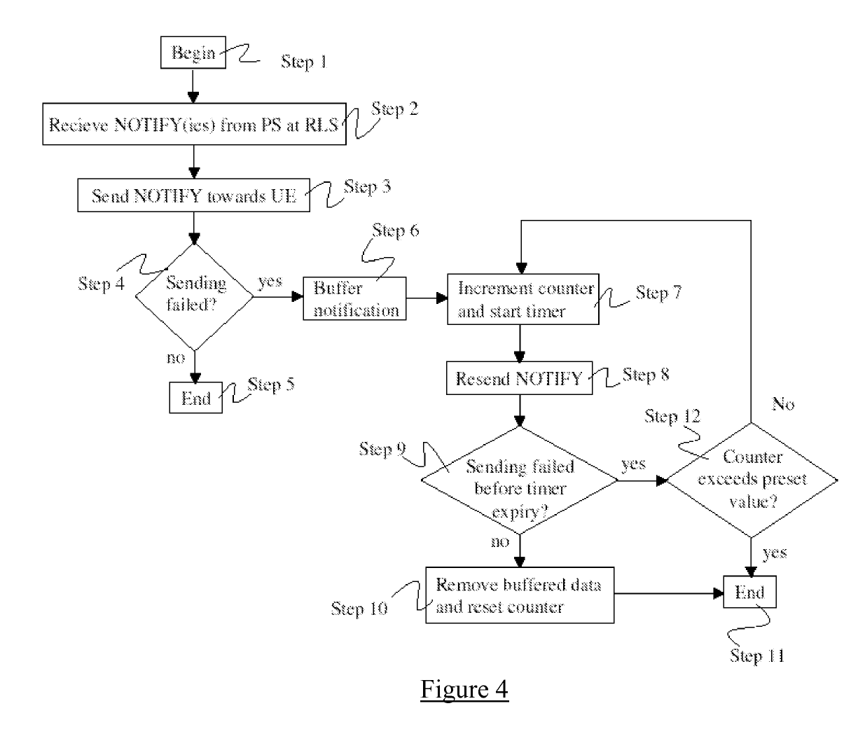

FIG. 4 is a flow diagram illustrating a process for handling notifications in a presence service. The process begins at step 1, and at step 2 one or more NOTIFY messages are received from a PS. At step 3, a single (possibly aggregated) NOTIFY is sent towards the UE. If the sending is successful (step) 4, the process ends (step 5). However, if the sending process fails, at step 6 the notification information is buffered. At step 7, the retry counter is reset and the timer started. At step 8 the NOTIFY is resent. If the resend succeeds (step 9), the notification data is deleted from the buffer and the counter reset to zero (step 10). The process ends at step 11. However, if the retry again fails, at step 12 the current counter value is compared against the preconfigured value. If that value is exceeded, the process ends at step 11. In this case, the notification information remains in the buffer. If the counter is not exceeded, the retry is repeated from step 7.

It will also be appreciated by the person of skill in the art that various modifications may be made to the above-described embodiments without departing from the scope of the present invention as defined by the appended claims. For example, rather than buffering the notification at the RLS after the configured number of resend attempts has been exceeded, at this point the UE's watching subscription may indeed be terminated. The procedure for resending the notify may also be applied to the case of notifications containing requests from peer users to subscribe to the presence information of a given user. Contrary to the currently proposed mechanism, that given users backend subscriptions will not be terminated in the event of a resend attempt. Similarly, the mechanism may be applied to the case of network based document management services, such as the maintenance of XML documents containing user data on network based XML Document Management Servers (XDMS). For example, when a change is made to such a document and a NOTIFY containing the change is sent towards a user, failure of the initial NOTIFY will result in the message being resent rather than merely dropped.

1. A method of handling notifications associated with a presence service provided over a communications network and to which service a plurality of users are subscribed, the method comprising:
subscribing a first user to presence information of one or more peer users;
sending a notification from said network towards a first user, the notification containing presence information relating to the or at least one of said peer users;
detecting a failure to deliver said notification; and
resending said notification one or more times.

2. A method according to claim 1 and comprising, in the event that said resending fails a predefined number of times, attempting no further resends, whilst maintaining the subscription of said first user to presence information of said one or more peer users.

3. A method according to claim 2 and comprising buffering said notification within the network following the final resend attempt.

4. A method according to claim 3 and comprising, upon occurrence of a further notification event, including said notification with a further notification sent towards said first user.

5. A method according to claim 1 and comprising, in the event of repeated failure to deliver said notification, terminating the subscription of said first user to presence information of said one or more peer users.

6. A method according to any one of the preceding claims, wherein said presence service is a SIP-based service, and said notification is a SIP NOTIFY.

7. A method according to claim 6, wherein failure to deliver a notification is detected by receipt of one of:
408 Request Timeout;
480 Temporarily Unavailable;
486 Busy Here;
500 Server Internal Error;
503 Service Unavailable;
504 Server Time-out;
600 Busy Everywhere.

8. A method according to claim 6 or 7, wherein said presence service is an IP Multimedia Subsystem based service.

9. A method according to any one of the preceding claims, the method being carried out at an IP Multimedia Subsystem Application Server.

10. A method according to claim 8, wherein said Application Server is a Resource List Server.

11. Apparatus configured to handle notifications of presence information associated with a presence service provided over a communications network and to which service a plurality of users are subscribed, the apparatus comprising:
a sending unit for sending a notification towards a first user, the notification containing presence information relating to one or more peer users;
a failure detection unit for detecting a failure to deliver said notification; and
a resending unit for causing said notifications to be resent one or more times.

12. Apparatus according to claim 11, said resending unit comprising a counter for counting the number of resend attempts, the apparatus further comprising a processing unit for terminating the resending attempts if the counter exceeds a preconfigured number, whilst maintaining the subscription of said first user to presence information of said one or more peer users.

13. Apparatus according to claim 12 and comprising a buffer, the processing unit being configured to store said notification in the buffer should the number of resend attempts exceed said preconfigured number.

14. Apparatus according to any one of claims 11 to 13, the apparatus being configured to operate as an Application Server within an IP Multimedia Subsystem.

15. Apparatus according to claim 14, the apparatus being configured to operate as a Resource List Server.

16. A method of handling notifications associated with a presence service provided over a communications network and to which service a plurality of users are subscribed, the method comprising:
sending a notification from said network towards a first user, the notification containing a request by a second user to subscribe to the presence information of said first user;
detecting a failure to deliver said notification; and
resending said notification one or more times.

17. A method according to claim 16 and comprising, in the event that said resending fails a predefined number of times, attempting no further resends, whilst maintaining the subscription of said first user to presence information of one or more peer users.

18. A method of handling notifications associated with a document change watching service provided over a communications network and to which service a first user is subscribed, the method comprising:
sending a notification from said network towards said first user, the notification containing details of one or more changes to a document residing in the network;
detecting a failure to deliver said notification; and
resending said notification one or more times.

19. A method according to claim 18, wherein said document is an XML document held on an XDMS within the network.
